(19) United States
(12) Patent Application Publication
(10) Pub. No.: US 2011/0019247 A1
(43) Pub. Date: Jan. 27, 2011

(54) IMAGING SYSTEM AND METHOD

(75) Inventor: Jeffrey Raynor, Edinburgh (GB)

Correspondence Address: GARDERE WYNNE SEWELL LLP;INTELLECTUAL PROPERTY SECTION, 3000 THANKSGIVING TOWER, 1601 ELM ST, DALLAS, TX, 75201-4761, US

(73) Assignee: STMicroelectronics (Research & Development) Limited, Marlow (GB)

(21) Appl. No.: 12/843,408

(22) Filed: Jul. 26, 2010

(30) Foreign Application Priority Data
Jul. 27, 2009 (GB) 0912981.8

(51) Int. Cl. H04N 1/04

(52) U.S. Cl. 358/482

(57) ABSTRACT

An imaging system for a scanner includes a sensor and a rod lens. The sensor has a linear array of photosensitive elements arranged in three rows and disposed at an angle such that the rows are at different distances from the lens and the object being scanned. When changes in focus occur, for example in scanning a book or a 3D object, the photosensitive elements giving the sharpest image are selected. The angle is achieved by mounting the sensor to a PCB via solder bumps arranged along one side of the sensor.

### PRIORITY CLAIM

This application claims priority from United Kingdom Patent Application No. 0912981.8 filed Jul. 27, 2009, the disclosure of which is hereby incorporated by reference.

### TECHNICAL FIELD

This invention relates to imaging systems which use a 2-D array of picture elements.

### BACKGROUND

One example of an imaging system is in flat bed scanners, where it is common to use an image sensor comprising a single row of pixels, typically having a length equal to the width of a page. The page is scanned by relative motion between the pixel row and the object being scanned, typically by moving the pixel row relative to a stationary platen. In this arrangement a simple optical system can be used, typically in the form of a rod lens at a fixed distance between the pixel array and the platen.

Scanners of this type are a useful tool for imaging paper documents as they provide a high resolution, accurate representation of the image, and can be produced at low cost. However, sometimes a non-flat object has to be scanned and the object is not at the optimal image plane; examples of this are copying from a bound book with the page curved near the spine, or a slide in a slide holder. It would be advantageous to scan such objects clearly, which would require a focusing system.

In a system of the type discussed above, it would be possible to adjust the position of the rod lens to obtain good focus. However, this would require an actuator system to move the lens and the cost would not be acceptable in a cost-sensitive consumer appliance. Moreover, the additional mechanical complexity would adversely affect reliability.

Where the scanner is of the type having an optical reduction system, it would be possible to move the optics to ensure the object is in sharp focus. However, optical reduction systems are not popular, especially in consumer applications, as they require a larger scanner in order to allow for the optical path. They are also more expensive and mechanically complex.

There are also various “wavefront coding” systems to extend the depth of field. They require a phase shift mask to be inserted at the aperture point (field stop) and a great deal of digital processing to restore focus. They also introduce artifacts into the image.

There is therefore a need for a scanner sensor without moving parts and able to adapt to non-flat objects, varying object distances, or even mis-alignments between the sensor and the optics.

### SUMMARY

Accordingly, an imaging system for imaging an object placed approximately in an imaging plane comprises a generally linear array of photosensitive elements disposed generally parallel to said imaging plane and extending in a first direction, and a lens system in a fixed relationship to said array; said array and the lens system being mounted for movement together in a direction perpendicular to said first direction; and in which said array of photosensitive elements comprises a plurality of parallel rows of photosensitive elements mounted so as to be, in use, at a corresponding plurality of distances from said imaging plane.

This arrangement makes it possible to select between rows at any particular time to provide the optimal one from a range of focus.

Preferably, the ratio of the number of photosensitive elements in each row in said first direction to the number of parallel rows is at least 10:1. This gives an economical compromise between range of focus and total number of photosensitive elements.

Typically, there are three rows of photosensitive elements. Two rows are possible, but will give little choice of focus. Four or more would give greater discrimination but increase device cost and size.

The imaging system will typically include means for determining which one of the rows of photosensitive elements provides the best focus of an object being imaged. Said means may be provided by image processing within chips on which the photosensitive elements are formed, or as separate circuits.

The focus determining means may suitably comprise means for evaluating the contrast in output between pixels.

In one preferred embodiment, the photosensitive elements are provided on a photosensitive surface of one or more integrated circuits mounted on one or more printed circuit boards, and the or each integrated circuit is mounted on its respective circuit board at an angle.

The or each integrated circuit is preferably mounted at said angle by means of solder bumps formed adjacent one longitudinal edge of the integrated circuit.

The lens system may comprise a rod lens extending parallel to said array of photosensitive elements.

Additionally, a scanner is provided including an imaging system as defined above.

From another aspect, a method of forming an Image of an object placed approximately in an image plane comprises: providing a generally linear array of photosensitive elements disposed generally parallel to said imaging plane and extending in a first direction, said array comprising a plurality of parallel rows of photosensitive elements, arranging said array relative to the imaging plane such that said rows are at a corresponding plurality of distances from the imaging plane, and effecting relative movement between said array and the imaging plane in a second direction perpendicular to the first direction while focusing light from the imaging plane onto the array through a lens system.

The method may further comprise examining the output of the photosensitive elements to determine which provides a better focus.

### BRIEF DESCRIPTION OF THE DRAWINGS

An embodiment of the invention will now be described, by way of example only, with reference to the drawings, in which:

FIG. 1 is a schematic side view of an imaging system forming one embodiment of the invention;

FIG. 2 shows part of FIG. 1 in greater detail; and

FIG. 3 is an underneath plan view corresponding to FIG. 2.

### DETAILED DESCRIPTION OF THE DRAWINGS

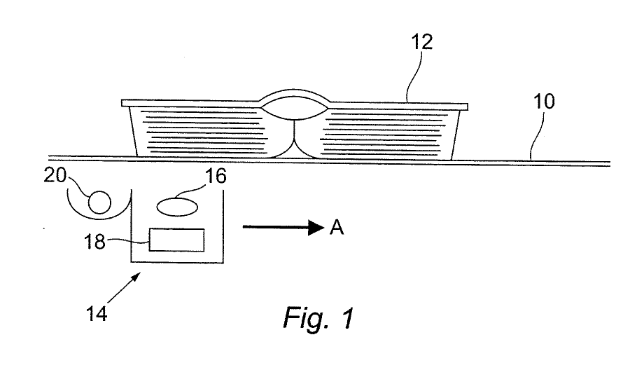

Referring to FIG. 1, a scanner includes a transparent platen 10 on which an object 12 such as a book may be placed. The scanner includes an imaging system generally designated at 14 which extends across the width of the platen 10 and can be traversed along the length of the platen 10 in the direction A. The imaging system 14 comprises a lens 16 and a photosensitive array 18. Illumination means are provided to illuminate the object 12, for example in the form of a tubular cold cathode lamp 20 moving with the imaging system 14.

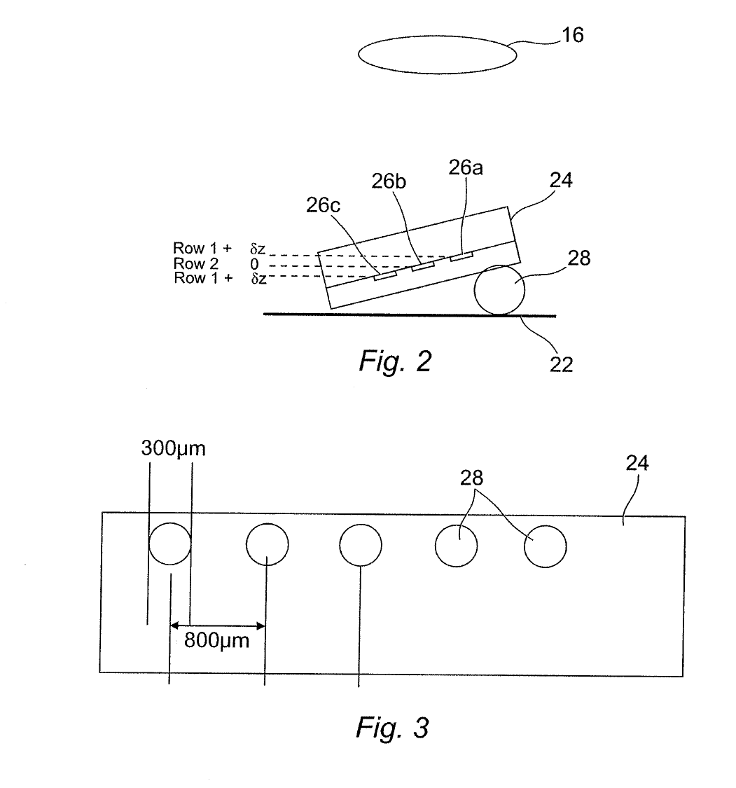

Referring to FIGS. 2 and 3, the photosensitive array 18 comprises a printed circuit board 22 on which a sensor 24 is mounted. The sensor 24 comprises an integrated circuit (or in practice a row of integrated circuits) spanning across the imaging system. In the prior art, a single row of photosensitive elements would be formed. In the present invention, there is provided a plurality of rows, for example in the illustrated embodiment there are three rows 26a, 26b, and 26c.

Additionally, the sensor 24 is mounted at a slight angle to the plane parallel to the platen 10, with the result that the rows 26a, 26b and 26c are at different distances from the lens 16. A suitable range of angles is between 2° and 8°. For a pixel pitch of 50 μm, for example, this would give a difference in distance between rows of 10 μm to 40 μm.

In the embodiment shown, the angled mounting of the sensor is achieved by mounting the sensor 24 at an angle to the PCB 22 by means of “through silicon via” (also referred to as chip scale packaging or wafer scale packaging) solder bumps 28 along one side of the array. Alternatively, the sensor 24 could be mounted conventionally on the PCB 22, and the PCB 22 mounted at an angle on its supporting structure. The use of solder bumps as shown is preferred; this technique is not only well suited to mass production, but reflow of the solder bumps produces a self-aligning effect of the chip on the PCB because of surface tension effects, and thus assists in producing an accurate linear array from a number of separate chips.

During operation, the row of photosensors which produces the sharpest image is identified and their output used. This can be done, for example, by examining horizontally neighboring pixels for greater contrast. Methods of establishing maximum contrast are well known in for example autofocus systems, typically by detecting the sharpest transition between light and dark, or the highest spatial frequency content.

The sensor 24 may be of any suitable form. Most suitably, the sensor 24 will be a CMOS integrated circuit with active pixels and include the image processing circuitry required to select the pixels to be used and output the image data in an appropriate form.

The invention thus provides a simple, all electronic focusing system and method suitable for use in low cost mass produced scanners.

What is claimed is:

1. An imaging system for imaging an object placed approximately in an imaging plane, the system comprising:
an array of photosensitive elements disposed generally parallel to said imaging plane and extending in a first direction, and
a lens system in a fixed relationship to said array;
said array and the lens system being mounted for movement together in a direction perpendicular to said first direction;
wherein said array of photosensitive elements comprises a plurality of parallel rows of photosensitive elements, each row extending in the first direction and mounted so that, in use, each row is positioned at a different distance from said imaging plane.

2. The imaging system according to claim 1, wherein a ratio of the number of photosensitive elements in each row in said first direction to the number of parallel rows is at least 10:1.

3. The imaging system according to claim 1, wherein the plurality of parallel rows comprises three rows of photosensitive elements.

4. The imaging system according to claim 1, further including means for determining which one of the rows of photosensitive elements provides the best focus of an object being imaged.

5. The imaging system according to claim 4, wherein the means for determining means comprises means for evaluating contrast in output between pixels.

6. The imaging system according to claim 1, wherein the photosensitive elements are provided on a photosensitive surface of one or more integrated circuits mounted on one or more printed circuit boards, and the or each integrated circuit is mounted on its respective circuit board at an angle.

7. The imaging system according to claim 6, wherein the or each integrated circuit is mounted at said angle by means of solder bumps formed adjacent one longitudinal edge of the integrated circuit.

8. The imaging system according to claim 1, wherein the lens system comprises a rod lens extending parallel to said array of photosensitive elements.

9. The imaging system according to claim 1, wherein the movement of said array and the lens system functions as an object scanner.

10. A method of forming an image of an object placed approximately in an image plane, the method comprising:
providing a generally linear array of photosensitive elements disposed generally parallel to said imaging plane and extending in a first direction, said array comprising a plurality of parallel rows of photosensitive elements,
arranging said array relative to the imaging plane such that said rows are at a corresponding plurality of distances from the imaging plane, and
effecting relative movement between said array and the imaging plane in a second direction perpendicular to the first direction while focusing light from the imaging plane onto the array through a lens system.

11. The method of claim 10, further comprising examining the output of the photosensitive elements to determine which provides a better focus.

12. The method of claim 10, further comprising selecting one of the rows of photosensitive elements as providing an image output having a better focus.

13. An imaging system, comprising:
a platen; and
an imager which moves in a first direction relative to said platen, said imager comprising:
a lens system;
a first row of photosensitive elements extending in a second direction perpendicular to said first direction, said first row positioned to receive light from said lens system;
a second row of photosensitive elements extending in the second direction perpendicular to said first direction, said second row positioned to receive light from said lens system; and
wherein a first distance from said first row to said lens system is different from a second distance from said second row to said lens system.

14. The imaging system according to claim 13, further including means for determining which of the first row and second rows is better focused on the received light.

15. The imaging system according to claim 14, wherein the means for determining comprises means for evaluating contrast in output between pixels.

16. The imaging system according to claim 13, wherein the lens system comprises a rod lens extending parallel to said array of photosensitive elements.

17. The imaging system according to claim 13 wherein the first and second rows of photosensitive elements are arranged in a first plane, that first plane set at a non-zero angle with respect to the platen.

18. An imaging system, comprising:
a platen; and
an imager which moves in a first direction relative to said platen, said imager comprising:
a first row of photosensitive elements extending in a second direction perpendicular to said first direction, said first row positioned to receive light from an object on said platen;
a second row of photosensitive elements extending in the second direction perpendicular to said first direction, said second row positioned to receive light from the object on said platen; and
wherein a first distance from said first row to said platen is different from a second distance from said second row to said platen.

19. The imaging system of claim 18, the imager further comprising a lens system for directing light from the object on said platen to the photosensitive elements of the first and second rows.

20. The imaging system of claim 19 wherein a third distance from said first row to said lens system is different from a fourth distance from said second row to said lens system

21. The imaging system of claim 18, further including means for determining which of the first row and second rows is better focused on the received light.

22. The imaging system of claim 21, wherein the means for determining comprises means for evaluating contrast in output between pixels.

23. The imaging system of claim 18 wherein the first and second rows of photosensitive elements are arranged in a first plane, that first plane set at a non-zero angle with respect to the platen.
